(19) United States
(12) Patent Application Publication
(10) Pub. No.: US 2016/0182858 A1
(43) Pub. Date: Jun. 23, 2016

(54) MULTIVISION DISPLAY APPARATUS

(71) Applicant: SAMSUNG ELECTRONICS CO., LTD., Suwon-si (KR)

(72) Inventors: Jung Hyun CHOI, Seoul (KR); Hyoung Hak Kim, Seongnam-si (KR); Dai Boong Lee, Hwaseong-si (KR)

(73) Assignee: SAMSUNG ELECTRONICS CO., LTD., Suwon-si (KR)

(21) Appl. No.: 14/884,932

(22) Filed: Oct. 16, 2015

(30) Foreign Application Priority Data
Dec. 17, 2014 (KR) 10-2014-0181965

(51) Int. Cl. H04N 7/14; G06F 3/14; G09G 5/14

(52) U.S. Cl. CPC H04N 7/144; G09G 5/14; G06F 3/1446; G09G 2300/026; G09G 2320/0261

(57) ABSTRACT

A multivision display apparatus which enables participants who conduct a video conference to conduct the video conference in a manner in which the participants keep eye contact with each other. The multivision display apparatus includes a plurality of display apparatuses which output images, a bezel provided on an edge of each of the plurality of display apparatuses, a light receiving device which is provided on the bezel positioned at the center of a screen formed with the plurality of display apparatuses to have a vertical length, and receives an image, and an image receiving device which is provided on an upper end of the bezel to be connected to the light receiving device, receives the image received by the light receiving device, generates image data, and transmits the image data to the display apparatuses.

### CROSS-REFERENCE TO RELATED APPLICATIONS

This application claims the priority benefit of Korean Patent Application No. 10-2014-0181965, filed on Dec. 17, 2014 in the Korean Intellectual Property Office, the disclosure of which is incorporated herein by reference.

### BACKGROUND

1. Field

Embodiment of the present disclosure relates to a multivision display apparatus formed with a plurality of display apparatuses.

2. Description of the Related Art

A multivision display apparatus may form a screen using a plurality of display apparatuses.

In general, a multivision display apparatus includes a plurality of display apparatuses which are vertically and laterally installed side by side, and the plurality of display apparatuses each displays a part of an entire screen, which is required to be displayed, of the multivision display apparatus.

Cameras are installed at an upper portion of a multivision display apparatus to conduct a video conference or the like.

Since a multivision display apparatus is formed with a plurality of display apparatuses, when a video conference is conducted through a large screen multivision display apparatus, the video conference is conducted in a manner in which a user looks up a camera installed at an upper portion of the multivision display apparatus, and thus, there is a problem in that the video conference may not be conducted in a manner in which listeners located at other sites keep eye contact with the speaker.

As the number of display apparatuses is increased, a screen of a multivision display apparatus is larger, and thus, it is more difficult to conduct a video conference in a manner in which participants located at both sites keep eye contact with each other.

In addition, when a camera is disposed on a screen of a multivision display apparatus so that participants located at both sites conduct a video conference in a manner in which they keep eye contact with each other, there is a problem in that a part of the screen is hidden by the camera.

### SUMMARY

Therefore, it is an aspect of the present disclosure to provide a multivision display apparatus which allows participants who are located at different sites and conduct a video conference to conduct the video conference in a manner in which they keep eye contact with each other.

Additional aspects of the disclosure will be set forth in part in the description which follows and, in part, will be apparent from the description, or may be learned by practice of the disclosure.

In accordance with one aspect of the present disclosure, a multivision display apparatus includes a plurality of display apparatuses which output images, a bezel provided on an edge of each of the plurality of display apparatuses, a light receiving device which is provided on the bezel positioned at the center of a screen formed with the plurality of display apparatuses to have a vertical length, and receives an image, and an image receiving device which is provided on an upper end of the bezel to be connected to the light receiving device, receives the image received by the light receiving device, generates image data, and transmits the image data to the display apparatuses.

The light receiving device may include a light receiver which receives an image from an external source, a body tube which connects the light receiver and the image receiving device, and a prism which is provided inside the body tube, reflects the image received by the light receiver to the image receiving device.

The light receiver may be provided with a lens which receives the image from the external source.

The body tube may be vertically provided on the display apparatuses in a forward direction of the display apparatuses, and include a light receiver installation portion on which the light receiver is installed, and a bent portion which is bent from the light receiver installation portion and connected to the image receiving device.

A length of the body tube may be adjustable.

The reflector may be provided in a portion at which the body tube is bent, and may reflect the image received by the light receiver to the image receiving device.

The image receiving device may include an image sensor which senses the image reflected by the reflector, and a sensor light receiver which performs adjustment such that the image reflected by the reflector is correctly received by the image sensor.

The sensor light receiver may be provided with a lens, and may perform adjustment such that the image reflected by the reflector is correctly received by the image sensor according to a distance change between the sensor light receiver and the reflector based on length adjustment of the body tube.

The light receiving device and the image receiving device may be provided in pluralities.

The plurality of light receiving devices may respectively receive separated images, the separated images received thereby may be transmitted through the plurality of image receiving devices to the display apparatuses, and the display apparatuses may output the images which have the same arrangement as the images received by the plurality of light receiving devices.

The plurality of light receiving devices and the image receiving devices may generate stereo images, and may enable the plurality of display apparatuses to output three dimensional images.

In accordance with another aspect of the present disclosure, a multivision display apparatus includes a plurality of display apparatuses which output images, a bezel provided on an edge of each of the plurality of display apparatuses, a light receiving device which is provided on the bezel positioned at the center of a screen formed with the plurality of display apparatuses to have a vertical length, and receives an image, and of which the length is vertically adjustable, and an image receiving device which is provided to be connected to the light receiving device, receives the image received by the light receiving device, generates image data, and transmits the image data to the display apparatuses.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view illustrating a multivision display apparatus according to one embodiment of the present disclosure;

FIG. 2 is a front view of a multivision display apparatus according to one embodiment of the present disclosure;

FIG. 3 is a side cross-sectional view of a multivision display apparatus according to one embodiment of the present disclosure;

FIG. 4 is a view illustrating an aspect in which the length of a body tube shown in FIG. 3 is adjusted;

FIG. 5 is a view illustrating an aspect in which a plurality of light receiving devices and image receiving devices according to another embodiment of the present disclosure are provided;

FIG. 6 is a view illustrating an aspect in which a plurality of light receiving devices and image receiving devices according to another embodiment of the present disclosure are provided and each of the plurality of light receiving devices receives a separated image; and

FIG. 7 is a view illustrating an aspect in which images having the same arrangement as images separately received by each of the plurality of light receiving devices shown in FIG. 6 are output by a plurality of display apparatuses.

### DETAILED DESCRIPTION

Reference will now be made in detail to embodiments of the present disclosure, examples of which are illustrated in the accompanying drawings, wherein like reference numerals refer to like elements throughout.

Hereinafter, embodiments of the present disclosure are described in detail referring to accompanying to drawings.

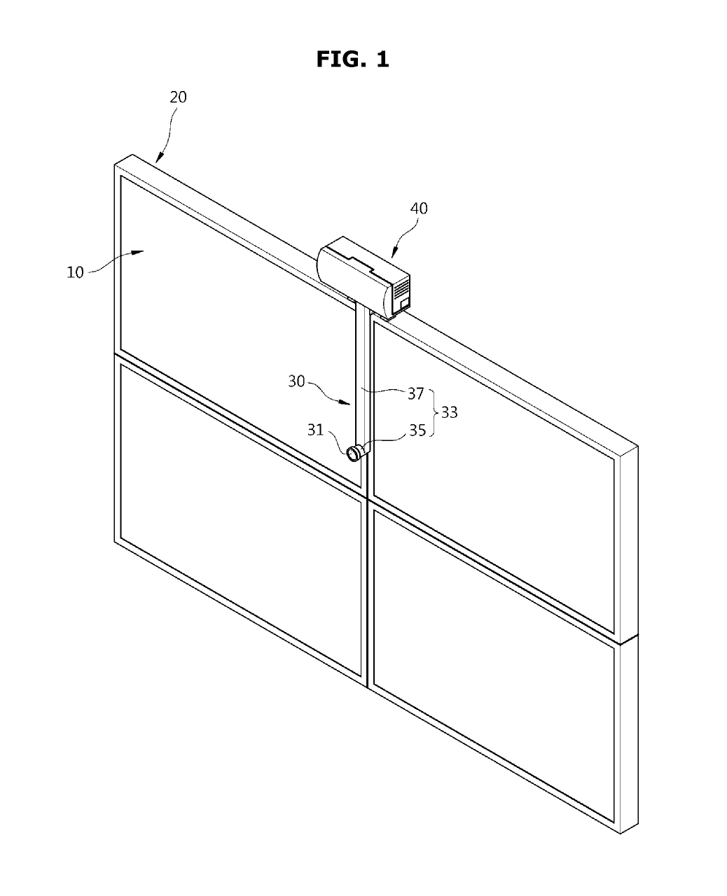

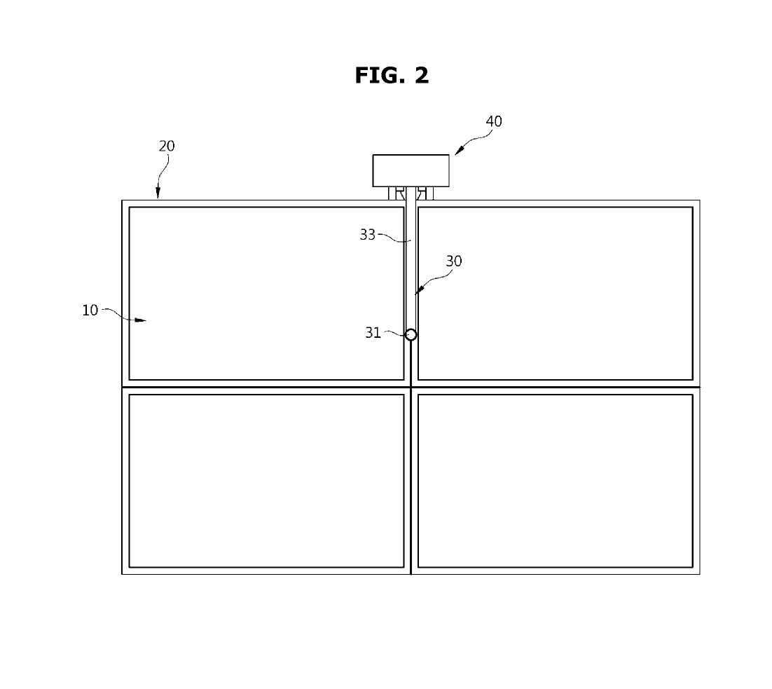

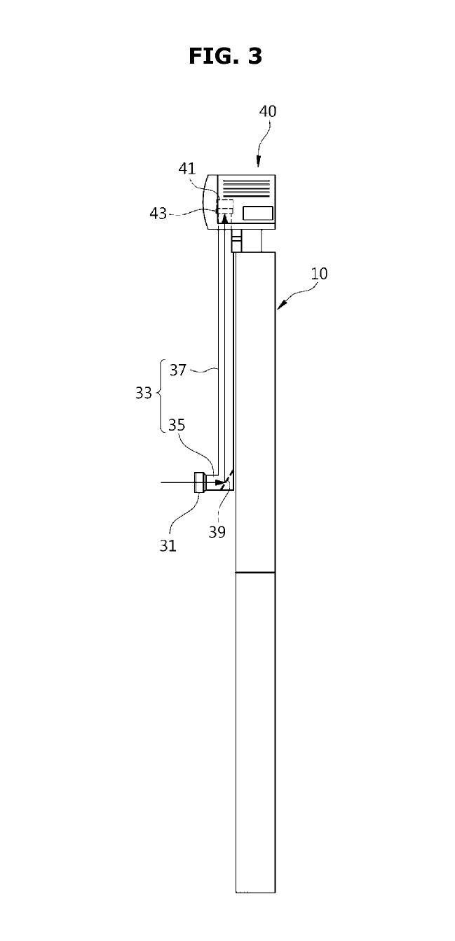

As illustrated in FIGS. 1 to 3, a multivision display apparatus includes a plurality of display apparatuses 10 in which images are output, a bezel 20 provided on an edge of each of the plurality of display apparatuses 10, light receiving devices 30 which are provided on the bezels 20 and receive the images, and image receiving devices 40 which are connected with the light receiving devices 30, receive the images received by the light receiving devices 30, generate image data, and transmit the image data to the display apparatuses 10.

The multivision display apparatus forms a large screen by combining the plurality of display apparatuses 10, and although it is illustrated that four display apparatuses 10 are combined to form the multivision display apparatus in the drawings, it is not limited thereto.

The plurality of display apparatuses 10 may each output images different from each other, or the plurality of display apparatuses 10 may be configured as one screen and may output images.

The bezel 20 forms the edge of each of the plurality of display apparatuses 10, and is shown as virtual black line in an entire screen of the multivision display apparatus.

The light receiving devices 30 which receive images for a video conference or the like, and the image receiving devices 40 which receive the images which are received by the light receiving devices 30, generate image data, and transmit the image data to image processors (not shown) of the display apparatuses 10 are provided on the multivision display apparatus.

Since the multivision display apparatus forms a large screen provided with the plurality of display apparatuses 10, in order to conduct a conference in a manner in which participants keep eye contact with each other when the video conference is conducted through the multivision display apparatus, the light receiving devices 30 which receive images should be positioned on the screen to correspond to their eye levels.

The light receiving devices 30 are provided on the bezels 20 which form edges of the plurality of display apparatuses 10.

The light receiving devices 30 may be vertically provided on the bezels 20 positioned at the center of the screen of the multivision display apparatus among the bezels 20.

The light receiving device 30 includes a light receiver 31 which receives an image from an external source, a body tube 33 which connects the light receiver 31 and the image receiving device 40, and a reflector 39 which is provided inside the body tube 33, reflects the image received by the light receiver 31 to the image receiving device 40. The reflector 39 may be a prism.

The light receiver 31 may be provided with lenses, is installed in front of a light receiver installation portion 35 of the body tube 33, and receives an image from the external source.

The body tube 33 is provided on the bezels 20 positioned at a center portion of the screen of the multivision display apparatus formed with the plurality of display apparatuses 10, and includes the light receiver installation portion 35 which is vertically provided on the display apparatuses 10 in a forward direction of the display apparatuses 10, and on which the light receiver 31 is installed, and a bent portion 37 which is bent from the light receiver installation portion 35 and connected to the image receiving device 40.

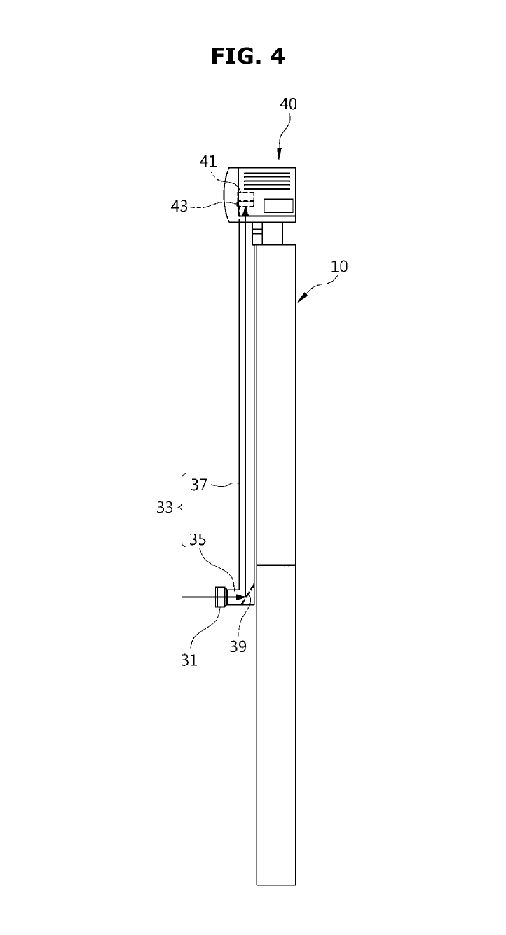

As illustrated in FIG. 4, the length of the body tube 33 is adjustable to correspond to the eye levels of users who conduct a video conference.

In addition, the length of the body tube 33 may also be adjustable according to a size of the entire screen of the multivision display apparatus provided with the plurality of display apparatuses 10.

The length of the body tube 33 may be changed by replacing it with another body tube 33 having a different length, or the length of the body tube 33 itself may also be adjustable.

The prism 39 is provided in a portion at which the bent portion 37 is bent from the light receiver installation portion 35 of the body tube 33, and reflects an image received from the light receiver 31 to the image receiving device 40.

The image receiving device 40 is provided on an upper portion of the upper bezel 20 of the display apparatus 10 positioned at an upper portion among the plurality of display apparatuses 10, and provided to be connected to the light receiving device 30 which receives an image from the external source.

Although it is illustrated in the drawings that the image receiving device 40 is provided on the upper portion of the upper bezel 20 of the display apparatus 10 positioned at the upper portion among the plurality of display apparatuses 10, is not limited thereto, and the image receiving device 40 may be provided on a lower portion of the lower bezel 20 of the display apparatus 10 positioned at a lower portion among the plurality of display apparatuses 10, or may be provided on the side bezel 20 of the display apparatus 10 positioned at an left end or right end among the plurality of display apparatuses 10.

That is, it is acceptable the image receiving device 40 is provided on an upper, lower, left side, or right side portion of the screen of the multivision display apparatus as long as the screen formed with the plurality of display apparatuses 10 is not blocked, and the image receiving device 40 is provided to be connected with the light receiving device 30.

When the image receiving device 40 is positioned at the upper or lower portion of the screen formed with the plurality of display apparatuses 10, the light receiving device 30 may be provided along the bezel 20 to have a vertical length, however, when the image receiving device 40 is positioned at the left or right side of the screen, the light receiving device 30 may be provided along the bezel 20 to have a lateral length.

The image receiving device 40 includes an image sensor 41 which senses an image reflected by the prism 39, and a sensor light receiver 43 which performs adjustment such that the image reflected by the prism 39 is correctly received by the image sensor 41.

When an image received by the light receiver 31 is reflected by the prism 39 and transmitted to the image sensor 41, the image sensor 41 generates image data and transmits the image data to an image processor of the display apparatus 10.

The image data transmitted to the image processor of the display apparatus 10 is output to a screen through the display apparatus 10.

Since the distance between the sensor light receiver 43 and the prism 39 is changed according to the length of the body tube 33 which is adjusted to correspond to the eye levels of participants who conduct a conference or is adjusted according to a size of the entire screen provided with the plurality of display apparatuses 10, the sensor light receiver 43 is adjusted so that an image reflected by the prism 39 is correctly received by the image sensor 41 according to a distance change between the sensor light receiver 43 and the prism 39.

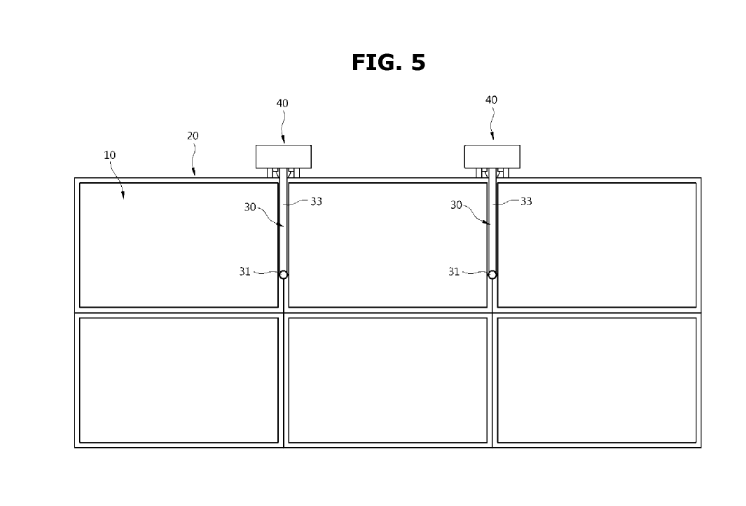

As illustrated in FIG. 5, the light receiving device 30 and the image receiving device 40 may each be provided in a plurality.

The light receiving device 30 is provided to correspond in number to the image receiving device 40.

When the light receiving device 30 and the image receiving device 40 are provided in a plurality, a stereo image may be generated and output to the screen of the multivision display apparatus formed with the plurality of display apparatuses 10, and thus, a three dimensional video conference may be available.

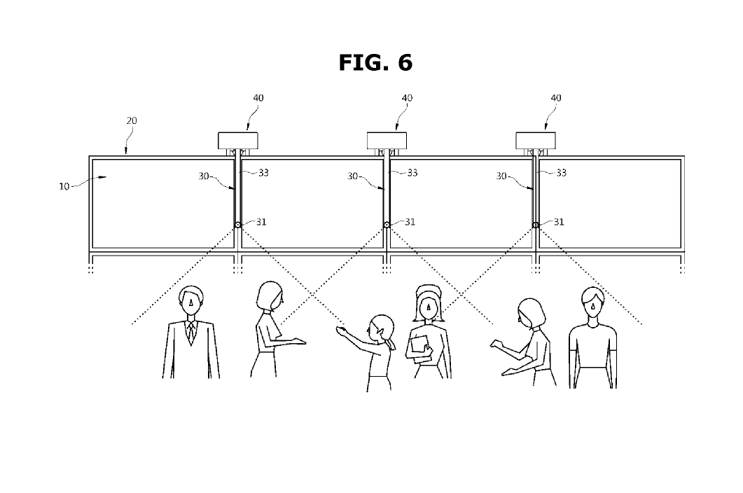

In addition, as illustrated in FIG. 6, when there are many participants who conduct a video conference, the light receiving device 30 and the image receiving device 40 may be provided in a plurality so that images of all participants may be output to the plurality of display apparatuses 10.

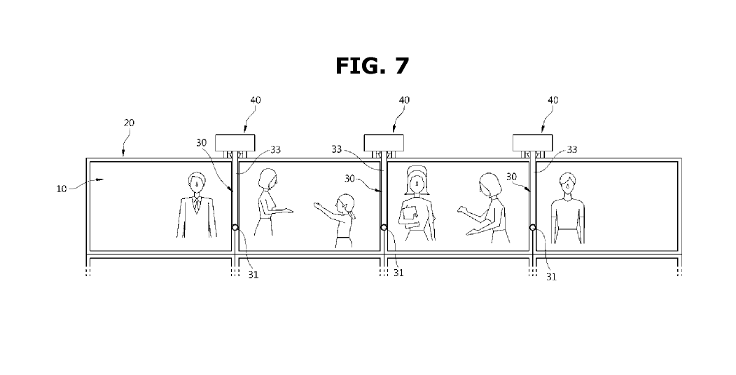

The plurality of light receiving devices 30 may each receive a separated image, the separated images received by the light receiving devices 30 may be transmitted through the image receiving devices 40 respectively connected to the plurality of light receiving devices 30 to the display apparatuses 10, as illustrated in FIG. 7, so that the plurality of display apparatuses 10 output the images which have the same arrangement as the images received by the plurality of light receiving devices 30.

In addition, although it is not shown in the drawing, when there are many participants who conduct a video conference, the lengths of the body tubes 33 may be adjusted to be different from each other and disposed to correspond to the eye level of each of the participants.

As described above, when the light receiving device 30 which receives an image from the external source is positioned at the center of the screen of the multivision display apparatus formed with the plurality of display apparatuses 10 and the length thereof is adjusted to correspond to the eye levels of participants who conduct a video conference, the participants who conduct the video conference may conduct the video conference in a face to face manner.

As is apparent from the above description, a multivision display apparatus in accordance with an embodiment of the present disclosure enables participants located at different sites to conduct a video conference in a manner in which the participants keep eye contact, and thus, the video conference may be conducted more naturally.

Although embodiments of the present disclosure, that is a multivision display apparatus, have been shown and described with specific shapes and orientations, it would be appreciated by those skilled in the art that modifications and variations may be made in these embodiments without departing from the principles and spirit of the disclosure, and all the modifications and variations fall within the scope of the appended claims.

What is claimed is:

1. A multivision display apparatus comprising:
a plurality of display apparatuses which output images;
a bezel provided on an edge of each of the plurality of display apparatuses;
a light receiving device which is provided on the bezel positioned at a center of a screen formed with the plurality of display apparatuses to have a vertical length, and receives an image; and
an image receiving device which is provided on an upper end of the bezel to be connected to the light receiving device, receives the image received by the light receiving device, generates image data, and transmits the image data to the display apparatuses.

2. The multivision display apparatus of claim 1, wherein the light receiving device includes:
a light receiver which receives an image from an external source;
a body tube which connects the light receiver and the image receiving device; and
a reflector which is provided inside the body tube, reflects the image received by the light receiver to the image receiving device.

3. The multivision display apparatus of claim 2, wherein the light receiver is provided with a lens to receive the image from the external source.

4. The multivision display apparatus of claim 3, wherein the body tube is vertically provided on the display apparatuses in a forward direction of the display apparatuses, and includes a light receiver installation portion on which the light receiver is installed.

5. The multivision display apparatus of claim 4, wherein a length of the body tube is adjustable so that a position of the light receiver is changed according to the adjusted length of the body tube.

6. The multivision display apparatus of claim 5, wherein the reflector is provided in a portion at which the body tube is bent, and reflects the image received by the light receiver to the image receiving device.

7. The multivision display apparatus of claim 6, wherein the image receiving device includes:
an image sensor which senses the image reflected by the reflector; and
a sensor light receiver which performs adjustment such that the image reflected by the reflector is correctly received by the image sensor.

8. The multivision display apparatus of claim 7, wherein the sensor light receiver performs adjustment such that the image reflected by the reflector is correctly received by the image sensor according to a distance change between the sensor light receiver and the reflector based on the adjustment of the length of the body tube.

9. The multivision display apparatus of claim 1, further comprising a plurality of light receiving devices and a plurality of image receiving devices.

10. The multivision display apparatus of claim 9, wherein the plurality of light receiving devices respectively receive separated images, the separated images received thereby are transmitted through the plurality of image receiving devices to the display apparatuses, and the display apparatuses output the images which have same arrangement as the images received by the plurality of light receiving devices.

11. The multivision display apparatus of claim 9, wherein the plurality of light receiving devices and the plurality of image receiving devices generate stereo images, and enable the plurality of display apparatuses to output three dimensional images.

12. A multivision display apparatus comprising:
a plurality of display apparatuses which output images;
a bezel provided on an edge of each of the plurality of display apparatuses;
a light receiving device which is provided on the bezel positioned at a center of a screen formed with the plurality of display apparatuses to have a vertical length, and, receives an image, and of which the length is vertically adjustable; and
an image receiving device which is provided to be connected to the light receiving device, receives an image received by the light receiving device, generates an image data, and transmits the image data to the display apparatuses.

13. The multivision display apparatus of claim 2, wherein the reflector is a prism.

14. The multivision display apparatus of claim 4, wherein the body tube includes a bent portion which is bent from the light receiver installation portion and extends to be connected to the image receiving device.

15. The multivision display apparatus of claim 8, wherein the sensor light receiver is provided with a lens and the adjustment is made between the lens of the sensor light receiver and the lens of the light receiver based based on the adjustment of the length of the body tube.

16. A multivision display apparatus comprising:
a plurality of display apparatuses;
a plurality of bezels to wrap edges of the display apparatuses;
a light receiving device, which is to be placed on the bezels of two adjacent display apparatuses, and receives an image; and
an image receiving device, which is provided on a top portion of the bezel, to be connected to the light receiving device and to receive the image received by the light receiving device, generates image data, and transmits the image data to the display apparatuses.
